(19) United States
(12) Patent Application Publication
(10) Pub. No.: US 2025/0217695 A1
(43) Pub. Date: Jul. 3, 2025

(54) SYSTEM AND METHODS FOR ENSURING SECURITY, TRUST, AND PRIVACY IN GENERATIVE ARTIFICIAL INTELLIGENCE (AI) CONTENT WITH QUANTUM BLOCKCHAINS AND QUANTUM DIGITAL SIGNATURES

(71) Applicants: AT&T Intellectual Property I, L.P., Atlanta, GA (US); AT&T Mobility II LLC, Atlanta, GA (US); Interwise Ltd., Airport City (IL)

(72) Inventors: Mark Stockert, San Antonio, TX (US); William Trost, Mequon, WI (US); Thomas J. Routt, Sequim, WA (US); Jerry Robinson, Middletown, NJ (US); Venson Shaw, Kirkland, WA (US); Eynat Weinberg Nordman, Ramat Hasharon (IL)

(21) Appl. No.: 18/401,242

(22) Filed: Dec. 29, 2023

(51) Int. Cl. G06N 20/00

(52) U.S. Cl. CPC G06N 20/00

(57) ABSTRACT

A method for providing quantum computation-based security solutions for generative artificial intelligence content includes generating an item of new content based on an input, and using a generative artificial intelligence foundation model that has been trained to generate items of new content having characteristics that mimic characteristics of content included in a set of training data, storing the item of new content in a quantum temporal blockchain, detecting an action performed by the generative artificial intelligence foundation model against the item of new content, and logging the action in the quantum temporal blockchain.

The present disclosure relates generally to generative artificial intelligence, and relates more particularly to devices, non-transitory computer-readable media, and methods for providing quantum computation-based security solutions for generative artificial intelligence content.

### BACKGROUND

Generative artificial intelligence (AI) is a specific type of artificial intelligence that can be used to create synthetic content of various types, including text, images, audio, and/or video. Generative AI models work by learning the patterns and structures of their input training data and then generating new data that mimics the characteristics of the training data. Generative AI models have the potential to revolutionize content creation. Moreover, the simplicity of recently developed user interfaces for generative AI models has made it possible for even users with minimal AI experience to generate high-quality content.

### SUMMARY

The present disclosure broadly discloses methods, computer-readable media, and systems for providing quantum computation-based security solutions for generative artificial intelligence content. In one example, a method for providing quantum computation-based security solutions for generative artificial intelligence content includes generating an item of new content based on an input, and using a generative artificial intelligence foundation model that has been trained to generate items of new content having characteristics that mimic characteristics of content included in a set of training data, storing the item of new content in a quantum temporal blockchain, detecting an action performed by the generative artificial intelligence foundation model against the item of new content, and logging the action in the quantum temporal blockchain.

In another example, a non-transitory computer-readable medium may store instructions which, when executed by a processing system including at least one processor, cause the processing system to perform operations. The operations may include generating an item of new content based on an input, and using a generative artificial intelligence foundation model that has been trained to generate items of new content having characteristics that mimic characteristics of content included in a set of training data, storing the item of new content in a quantum temporal blockchain, detecting an action performed by the generative artificial intelligence foundation model against the item of new content, and logging the action in the quantum temporal blockchain.

In another example, a device may include a processing system including at least one processor and a non-transitory computer-readable medium storing instructions which, when executed by the processing system, cause the processing system to perform operations. The operations may include generating an item of new content based on an input, and using a generative artificial intelligence foundation model that has been trained to generate items of new content having characteristics that mimic characteristics of content included in a set of training data, storing the item of new content in a quantum temporal blockchain, detecting an action performed by the generative artificial intelligence foundation model against the item of new content, and logging the action in the quantum temporal blockchain.

### BRIEF DESCRIPTION OF THE DRAWINGS

The teachings of the present disclosure can be readily understood by considering the following detailed description in conjunction with the accompanying drawings, in which:

FIG. 1A illustrates an example system in which examples of the present disclosure for providing quantum computation-based security solutions for generative artificial intelligence content may operate;

FIG. 1B illustrates an example in which the components of the system of FIG. 1A are distributed and connected to a quantum network;

FIG. 2 illustrates an example of the distributed resource controller of FIG. 1A and FIG. 1B;

FIG. 3 illustrates a portion of an example quantum temporal blockchain;

FIG. 4 illustrates a flowchart of an example method for providing quantum computation-based security solutions for generative artificial intelligence content, in accordance with the present disclosure; and

FIG. 5 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for providing quantum computation-based security solutions for generative AI content. As discussed above, generative AI is a specific type of artificial intelligence that can be used to create synthetic content of various types, including text, images, audio, and/or video. Generative AI models work by learning the patterns and structures of their input training data and then generating new data that mimics the characteristics of the training data. Generative AI models have the potential to revolutionize content creation. Moreover, the simplicity of recently developed user interfaces for generative AI models has made it possible for even users with minimal AI experience to generate high-quality content.

However, the potential for abuse of these generative AI models also presents significant security, trust, and privacy related challenges. For instance, generative AI content has been used to impersonate public figures, spread misinformation, and breach data privacy. Moreover, the generative AI models used to produce generative AI content may inadvertently learn biases that are subsequently applied to generated content, and opaque decision making processes may make it difficult to determine the reasoning behind certain decisions made by these models. Previous attempts to solve these challenges have focused on data anonymization, manual verification of content authenticity, and centralized access control. However, these solutions have limitations and often fail to address these challenges in a comprehensive manner.

Examples of the present disclosure provide quantum computation-based security solutions for generative AI content. Quantum computation stores information as quantum bits (or “qubits”), which are quantum generalizations of classical bits. Qubits can be represented as a two-to-n-level quantum system based on, for example, electronic/photonic spin and polarization, where: (1) the state of a qubit is a phase vector |ψ [symbol] (mathematical description of a quantum system, a complex-valued probability amplitude and the probabilities for possible results of measurements made on the system) in a linear superposition of states such as |ψ [symbol] =α|0 [symbol] +β|1 [symbol] ; (2) state vectors |0 [symbol] and |1 [symbol] are physical eigenstates of the logical observable and form a computational basis spanning a two-to-n dimensional Hilbert space (i.e., inner product space of two or more vectors, equal to the vector inner product between two or more matrix representations of those vectors containing |ψ [symbol] ; and (3) a collection of qubits comprises a multi-particle quantum system.

Quantum n computation can pursue all computational trajectories simultaneously based on quantum superposition (i.e., integration of all states between 0 and 1), whereas classical computation proceeds in a serial fashion. Quantum logic gates form basic quantum circuits that operate on qubits, are reversible with a few exceptions (unlike classical logic gates), and are unitary operators, described as unitary matrices relative to basis states. Quantum algorithms utilize quantum circuit gates to manipulate states of quantum systems, just as classical algorithms utilize classical logic gates (represented as a sequence of Boolean gates) to perform classical (non-quantum) computational operations.

Particular examples of the present disclosure apply quantum temporal blockchain and quantum digital signature (QDS) techniques to solve the inherent challenges related to the security, trust, and privacy in generative AI content. The immutable and decentralized nature of quantum temporal blockchains can be leveraged to ensure data privacy, prevent unauthorized use of data, and offer transparency and traceability of data in the generation of AI content. For instance, if an individual attempts to tamper with or change the information within even a single block of a quantum temporal blockchain, the entire quantum temporal blockchain will be destroyed. This eliminates the need for consensus mechanisms that are commonly found in classical blockchains. Moreover, quantum temporal blockchains are more difficult to modify than classical blockchains because once a new quantum block is formed, the previous quantum blocks disappear.

In further examples of the present disclosure, QDS can be used to enhance the security of quantum temporal blockchains by leveraging the principles of quantum mechanics to ensure the ingenuity and authenticity of transactions involving generative AI content. QDS securely generates and distributes cryptographic keys between two or more parties by exploiting unique properties of quantum states, such as superposition and entanglement. For instance, a QDS may be created by a quantum process that associates a unique quantum state (or set of quantum states) with data of a transaction. These quantum states are extremely sensitive to changes; thus, any attempts to change the data of the transaction would result in changes to the unique quantum states.

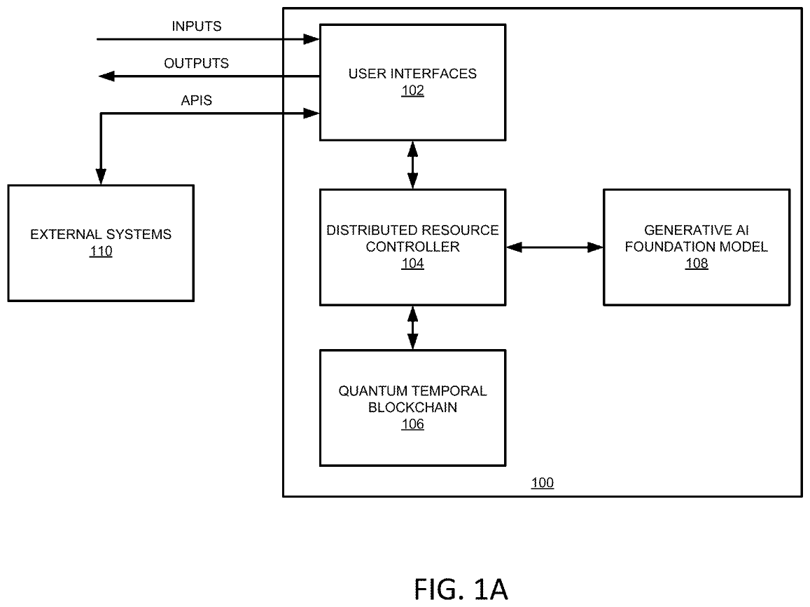

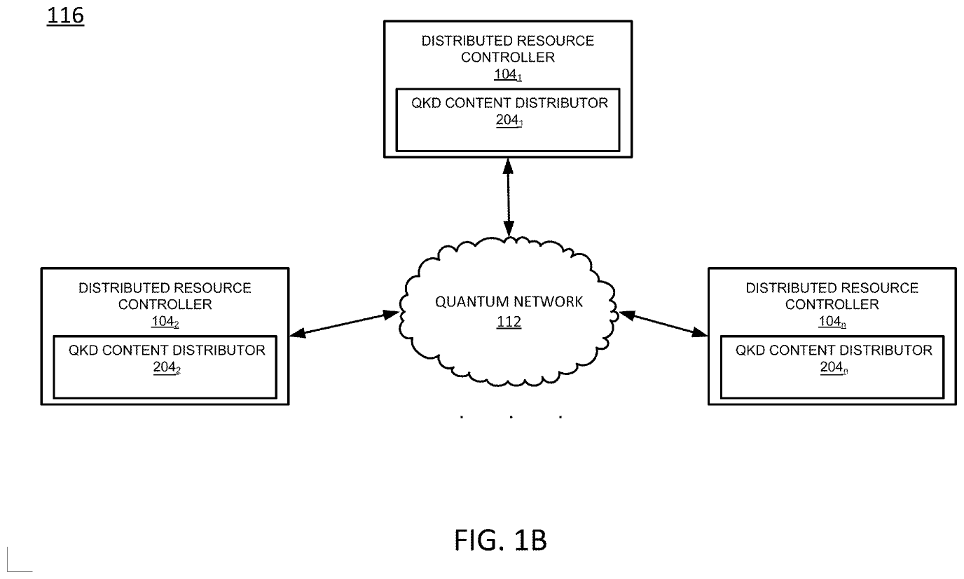

QDS allows a sender to sign a message in such a way that any recipient of the message can verify the authenticity of the message without the need to exchange encryption keys. Moreover, any attempt to modify or intercept a QDS will cause the quantum state to collapse and the individual attempting to modify or intercept the QDS to be exposed. Thus, by integrating quantum temporal blockchains and QDS, examples of the present disclosure can provide a secure system that safeguards the security, authenticity, integrity, and non-repudiation of transactions involving generative AI content. These and other aspects of the present disclosure are discussed in greater detail below in connection with the examples of FIGS. 1A-5.

To further aid in understanding the present disclosure, FIG. 1A illustrates an example system 100 in which examples of the present disclosure for providing quantum computation-based security solutions for generative artificial intelligence content may operate. As illustrated, the system 100 generally comprises user interfaces 102, a distributed resource controller 104, a quantum temporal blockchain 106, and a generative AI foundation model 108.

The user interfaces 102 may comprise any one or more interfaces that allow a user (e.g., a human user or one or more external systems 110) to provide inputs (e.g., questions or prompts) to the system 100 and to receive outputs responsive to the inputs (e.g., answers to the questions or prompts). For instance, using the user interfaces 102, a user may provide input prompts and other instructions to the generative AI foundation model 108, may view and interact with content generated by the generative AI foundation model 108, and may perform various other actions such as saving, sharing, or exporting the content generated by the generative AI foundation model 108.

The user interfaces 102 may be multi-modal, i.e., may allow for inputs and outputs to be provided in multiple modalities. For instance, the user interfaces may include at least one of: a graphical user interface (GUI), a touchscreen or haptic interface, an audio interface, or the like. The user interfaces 102 may be presented via a World Wide Web application, a mobile application, an application programming interface (API), or another form, depending upon the specific needs and context of use.

The design and functionality of the user interfaces 102 may greatly influence the experience of a user. Thus, the user interfaces 102 may be designed to be intuitive, user-friendly, and accessible to a wide range of users. The user interfaces 102 may additionally include features that allow users to provide feedback, report issues, or request assistance, thereby facilitating continuous improvement and adaptation of the system 100.

The generative AI foundation model 108 may comprise a machine learning model that is trained on a corpus of content, thereby enabling the trained model to generate new content that mimics the characteristics of the corpus of content. In one example, the corpus of content may comprise one or more different types of media content, including text, image, audio, and/or video content. Similarly, the generative AI foundation model 108 may be able to generate content of one or more of these media types. In one example, content generated by the generative AI foundation model 108 is generated in response to a specific input (e.g., question or prompt), which may be provided by a user via the user interfaces 102.

In one example, the generative AI foundation model 108 may be based on a deep learning technique, such as generative pre-trained transformers (GPTs) or other deep learning models, and may be capable of generating highly-realistic content similar to that which might be generated by a human content creator. For instance, the generative AI foundation model 108 may be capable of generating content ranging from simple sentences to fully formed paragraphs, photorealistic images, audio tracks (e.g., music, speech, or the like), and even video content.

Within the context of machine learning, “inferencing” refers to the process of making predictions using a trained machine learning model. For the generative AI foundation model 108, inferencing is the process of generating new content based on an input provided to the generative AI foundation model 108. Applications in which inferencing by the generative AI foundation model 108 may be useful include chatbots (e.g., using the generative AI foundation model 108 to generate human-like responses in a conversation), predictive text (e.g., using the generative AI foundation model 108 to suggest text for completing sentences in emails, text messages, word processing documents, and the like), translation (e.g., using the generative AI foundation model 108 to translate from one language into another, by training the generative AI foundation model 108 on pairs of sentences in two different languages), content generation (e.g., using the generative AI foundation model 108 to generate written articles, computer code, test plans, videos, images, and other content), and summarization (e.g., using the generative AI foundation model 108 to condense large text documents into shorter text documents that retain the most crucial information), and other applications.

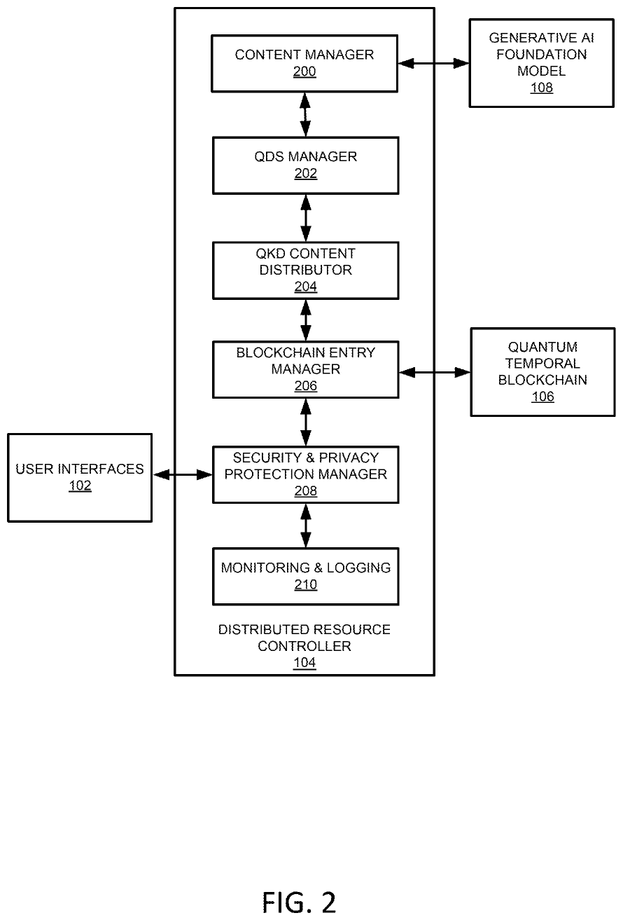

The distributed resource controller 104 may manage the various resources and components of the system 100. For instance, the distributed resource controller 104 may collect content generated by the generative AI foundation model 108, may hash the content, may generate and apply a quantum digital signature to the hashed content, may distribute the digitally signed content, may manage blockchain entries for the digitally signed content, may monitor and log errors related to the digitally signed content, may allocate resources of the system 100, and may enforce the security and privacy of the digitally signed content. One example of the distributed resource controller 104 is discussed in greater detail in connection with FIG. 2.

The quantum temporal blockchain 106 provides a decentralized and secure environment for data storage and transaction recording. In one example, the quantum temporal blockchain 106 stores metadata about the content generated by the generative AI foundation model 108, such as data used to train the generative AI foundation model 108, data about the performance of the generative AI foundation model 108, parameters (e.g., weights) used by the generative AI foundation model 108 in inferencing, and actions performed by the generative AI foundation model 108.

Each block in a quantum temporal blockchain 106 contains a unique identifier, thereby ensuring that the data stored in the quantum temporal blockchain 106 is tamper-proof and transparent. This provides users of the system 100 with a greater degree of control over personal information and instills confidence in the system 100. In addition, the quantum temporal blockchain 106 can facilitate transparent and automated agreements (e.g., smart contracts, discussed in further detail below), between AI systems, thereby improving efficiency and minimizing the potential for errors. The quantum temporal blockchain 106 can also help to prevent fraudulent activities within the system 100, improve traceability and transparency, and contribute to the scalability and efficiency of the system 100.

In one example, quantum temporal blockchain records each contain a plurality of fields for storing information related to content generated by the generative AI foundation model 108. In one example, the plurality of fields may include at least one of the following: record identifier (e.g., a unique identifier, separate from a hash of the content, that can be used to quickly locate and reference an entry for the content in the quantum temporal blockchain 106), quantum key distribution (QKD) session identifier (e.g., an identifier for the QKD session used to generate the encryption key, which may be useful for tracking and auditing the key distribution process), QDS (e.g., a QDS that verifies the integrity of the record contained in the quantum temporal blockchain record, which is generated using a QDS with a QKD system, as discussed in further detail below in connection with FIG. 2), timestamp (e.g., the time at which the content generated by the generative AI foundation model 108 was generated and added to the quantum temporal blockchain 106, which may be used for tracking the sequence of content generation), model identifier (e.g., an identifier indicating which generative AI foundation model 108 was used to generate the content, which is useful for tracking when different generative AI foundation models and/or different versions of the same generative AI foundation model are used over time), content type (e.g., whether the content generated by the generative AI foundation model 108 comprises text, images, video, audio, or the like, which may help to categorize and retrieve the content), or a content hash (e.g., a hashed representation of the content generated by the generative AI foundation model 108). Depending upon the application for which the generative AI foundation model 108 is used (e.g., smart contracts, 5G/6G/Next Generation content, location information, etc.), additional fields may be included in the quantum temporal blockchain 106.

FIG. 1B illustrates an example in which the components of the system 100 of FIG. 1A are distributed and connected to a quantum network 112. For instance, the distributed resource controller 104 may comprise a plurality of distributed resource controllers 104₁-104ₙ (hereinafter individually referred to as a “distributed resource controller 104” or collectively referred to as “distributed resource controllers 104”) connected to the quantum network 112. Secure communications between the distributed resource controllers 104 are facilitated at least in part by a plurality of QKD content distributors 204₁-204ₙ (hereinafter individually referred to as a “QKD content distributor 204” or collectively referred to as “QKD content distributors 204”), which provide interfaces to the quantum network 112.

FIG. 2 illustrates an example of the distributed resource controller 104 of FIG. 1A and FIG. 1B. In one example, the distributed resource controller 104 generally comprises a content manager 200, a QDS manager 202, a QKD content distributor 204, a blockchain entry manager 206, a security and privacy protection manager 208, and a monitoring and logging component 210.

In one example, the content manager 200 receives content generated by the generative AI foundation model 108 and applies a cryptographic hash function to the content to produce hashed content and to generate unique identifiers for the content.

The content manager 200 may provide the hashed content to the QDS manager 202, which may apply a quantum algorithm to the hashed content. In one example, the quantum algorithm may comprise a quantum entanglement-based algorithm. The quantum algorithm may associate the hashed content with a set of quantum states. The quantum states comprise a quantum digital signature for the content.

The QDS manager 202 provides the quantum digitally signed (and hashed) content to the QKD content distributor 204. The QDS content distributor 204, in turn, provides the quantum digitally signed content to a local blockchain entry manager 206, as well as to distributed blockchain entry managers. The “copies” of the quantum digitally signed content that the QKD content distributor 204 distributes to the blockchain entry managers are not clones; rather, the distribution protocol relies on the sharing of different quantum states that collectively make up the full quantum digital signature generated by the QDS manager 202.

The local blockchain entry manager 206 may create new entries in the quantum temporal blockchain 106 with the quantum digitally signed and hashed content received from the QKD content distributor 204. The local blockchain entry manager 206 ensures that each new block of the quantum temporal blockchain 106 is correctly entangled with the previous blocks.

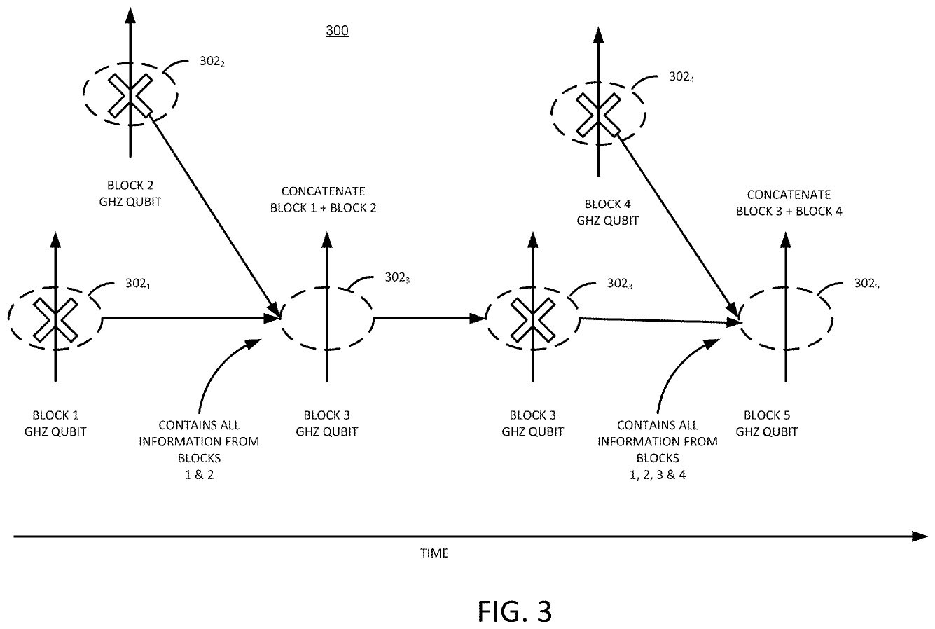

FIG. 3, for instance, illustrates a portion of an example quantum temporal blockchain 300. As illustrated, the quantum temporal blockchain 300 comprises a plurality of blocks 302₁-302₅ (hereinafter individually referred to as a “block 302” or collectively referred to as “blocks 302”). Block 302₁ and block 302₂ may be concatenated into block 302₃, so that block 302₃ contains all of the information contained in both of blocks 302₁ and 302₂. Subsequently, block 302₁ and block 302₂ may disappear. Similarly, block 302₃ and block 302₄ may be concatenated into block 302₅, so that block 302₅ contains all of the information contained in all of blocks 302₁, 302₂, 302₃, and 302₄. Subsequently, block 302₃ and block 302₄ may disappear.

In one example, the quantum temporal blockchain 300 stores the blocks 302 as Greenberger-Horne-Zeilinger (GHZ) state-based qubits of data. In one example, each GHZ qubit may store an item of content generated by the generative AI foundation model 108, as well as a timestamp at which the content was generated and an identifier of the generative AI foundation model 108 that was used to generate the content. In another example, each GHZ qubit may store data used to train the generative AI foundation model 108.

Thanks to the principles of quantum entanglement and superposition, all blocks 302 of the quantum temporal blockchain 300 are linked across both space (like in classical blockchains) and time. In quantum mechanics, entangled particles remain connected, so that actions performed on one particle affect the other particle with which the particle is entangled, even when the two particles are separated in space. A quantum temporal blockchain such as the quantum temporal blockchain 300 extends this entanglement property across time, so that each block 302 of the quantum temporal blockchain 300 is entangled with previous versions of itself.

As such, any attempt to alter the data in the quantum temporal blockchain 300 in the present would also alter the quantum temporal blockchain 300 in the past. However, since the past state of the data has already been observed, such an alteration would violate a fundamental principle of quantum mechanics (i.e., that the outcome of an event is not determined until the outcome is observed). As a result, any tampering with the data stored in the quantum temporal blockchain 300 would be instantly detectable and could be corrected.

Referring back to FIG. 2, the security and privacy protection manager 208 may enforce and manage security and privacy requirements across the system 100. In one example, the security and privacy protection manager 208 may implement strict access control measures, such as role-based access control (RBAC), which gives each user or system component the minimum necessary permissions to perform its respective functions. Thus, the security and privacy protection manager 208 controls who can access the system 100 and content generated by the generative AI foundation model 108.

The monitoring and logging component 210 may check the status of each distributed resource controller 104, as well as the status of the system 100 as a whole and usage and performance metrics of the system 100. The monitoring and logging component 210 may log any errors or issues that are detected. The monitoring and logging component 210 may also generate an alert when an error or issue is detected.

In one example of the present disclosure, the system 100 may be used to enhance the management and monitoring of 5G, 6G, and next-generation network slicing. Network slicing is a feature of 5G networks that allows for the creation of multiple virtual networks on top of a shared physical infrastructure. Each virtual network, or “slice,” can be tailored to specific use cases or services, such as Internet of Things (IoT), autonomous vehicles, medical systems and monitoring, or emergency services in wide-area disasters. In such a case, the generative AI foundation model 108 might acquire and summarize network slice information from a 5G, 6G, or next-generation network, and might produce as an output slice performance information, traffic analysis, summarization of traffic patterns to identify security risks, summarization of traffic patterns to facilitate anomaly reporting, or summarization of historical data to facilitate network planning and expansion.

For instance, the generative AI foundation model 108 can help condense the vast amount of data generated by each network slice into a manageable subset of key performance indicators (KPIs). This can help network operators to quickly assess the performance of individual network slices and to ensure that the individual network slices meet any applicable service level agreements (SLAs). A plurality of SLAs may then be stored in the quantum temporal blockchain 106.

In another example, the generative AI foundation model 108 can summarize network traffic patterns within and between 5G, 6G, and/or next-generation network slices. This can help network operators to identify potential bottlenecks, congestion points, or security risks within the network. Being able to identify potential bottlenecks, congestion points, and security risks may help the network operators to optimize routing, load balancing, and slice configuration to ensure smooth and secure operation for network users.

In another example, the generative AI foundation model 108 may use summarization techniques to help detect anomalies in network traffic patterns, such as sudden spikes in data transfers, repeated connection attempts, or unusual traffic volumes. These anomalies could signal potential security threats such as distributed denial of service (DDOS) attacks, intrusion attempts, or data exfiltration.

In another example, the generative AI foundation model 108 may use summarization techniques to summarize network traffic, which would enable network operators to monitor connection patterns between network slices and to identify suspicious activities such as unauthorized access attempts or unexpected cross-slice communication. Early detection of suspicious activities may help network operators to respond to potential threats promptly and to prevent potential intrusions or data breaches.

In another example, the generative AI foundation model 108 may use summarization techniques to summarize network traffic patterns, allowing network operators to identify when there may be a need for further network segmentation or isolation between network slices. Further network segmentation or isolation between network slices may help to ensure that sensitive data and critical services are protected from unauthorized access or potential threats originating from other network slices.

In another example, the generative AI foundation model 108 may use summarization techniques to summarize network traffic patterns, where the summarized patterns may reveal patterns that are indicative of malware or botnet activity, such as frequent communication with known command and control servers or a large number of connections to specific external Internet Protocol (IP) addresses. By helping network operators to identify patterns that are indicative of malware and botnet activity, the generative AI foundation model 108 may help the network operators to take appropriate measures to mitigate the risks posed by malware and botnets.

In another example, the generative AI foundation model 108 may use summarization techniques to summarize network traffic patterns, allowing network operators to assess the flow of data within and between network slices and to identify potential risks associated with data leakage or unauthorized data access. This can help network operators to implement appropriate security measures for the safeguarding of sensitive data, such as encryption or stricter access controls.

In another example, the generative AI foundation model 108 may use summarization techniques to summarize network traffic patterns, facilitating incident response and forensic analysis for security breaches. By providing a high-level overview of network activity, the generative AI foundation model 108 can help network operators to pinpoint the source and scope of a security breach and to respond effectively and in a manner that minimizes potential damage.

In another example, the generative AI foundation model 108 may use summarization techniques to detect anomalies or incidents with a 5G, 6G, or next-generation network, such as unexpected traffic spikes, performance degradation, or security breaches. By detecting these anomalies and incidents, the generative AI foundation model 108 can facilitate faster response and resolution of the anomalies and incidents and help to ensure the reliability and stability of each network slice.

In another example, the generative AI foundation model 108 may use summarization techniques to summarize historical data relating to network slice usage and performance. Summarization of the historical network slice usage and performance may provide insights into trends and growth patterns which can be used to inform future network planning and expansion decisions and thereby ensure that the network slices continue to meet the evolving needs of users and services.

In one particular example, the system 100 may be used to combine quantum temporal blockchain smart contracts with generative AI in order to create innovative solutions, streamline processes, and enable new business models. Within the context of the present disclosure, a “smart contract” is understood to refer to a digital protocol intended to facilitate, verify, and/or enforce the negotiation or execution of a contract. Thus, a smart contract comprises an automated mechanism involving two or more parties, where the parties' agreements are directly written into code and stored and replicated on a quantum temporal blockchain. Smart contracts are self-executing with the terms of the agreements directly written into this code; thus a smart contract will automatically execute actions when predetermined conditions are met. For instance, a smart contract for travel insurance could automatically issue a refund to an insured when the insured's flight is cancelled, assuming the cancellation of the flight was a condition that was written into the smart contract.

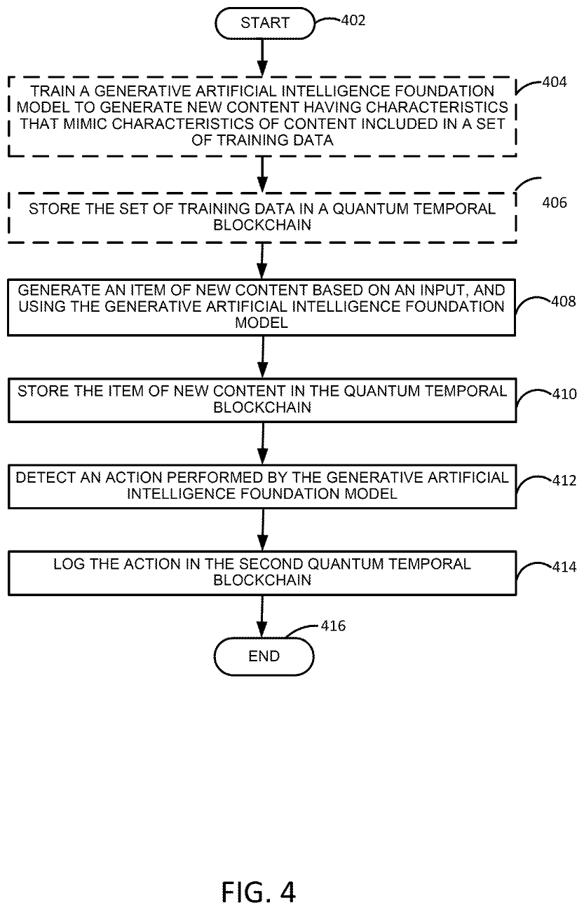

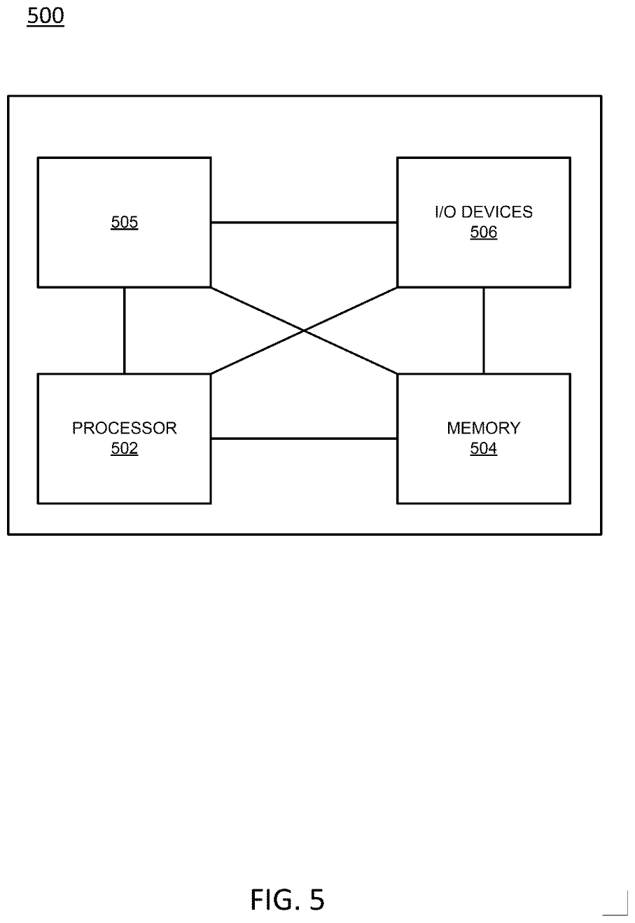

FIG. 4 illustrates a flowchart of an example method 400 for providing quantum computation-based security solutions for generative artificial intelligence content, in accordance with the present disclosure. In one example, steps, functions and/or operations of the method 400 may be performed by a system as illustrated in FIG. 1A, or any one or more components thereof. In another example, the steps, functions, or operations of method 400 may be performed by a computing device or system 500, and/or a processing system 502 (e.g., having at least one processor) as described in connection with FIG. 5 below. For instance, the computing device 500 may represent at least a portion of the system 100 in accordance with the present disclosure. For illustrative purposes, the method 400 is described in greater detail below in connection with an example performed by a processing system, such as processing system 502.

The method 400 begins in step 402. In optional step 404 (illustrated in phantom), the processing system may train a generative artificial intelligence foundation model to generate new content having characteristics that mimic characteristics of content included in a set of training data.

In one example, the generative AI foundation model may comprise a machine learning model that is trained on the set of training data, thereby enabling the trained model to generate new content that mimics the characteristics of the set of training data. In one example, the set of training data may comprise one or more different types of media content, including text, image, audio, and/or video content. Similarly, the generative AI foundation model may be able to generate content of one or more of these media types. In one example, content generated by the generative AI foundation model is generated in response to a specific input (e.g., question or prompt), which may be provided by a user. In one example, the input may relate to one or more terms of a smart contract that is stored in a quantum temporal blockchain.

In one example, the generative AI foundation model may be based in a deep learning technique, such as generative pre-trained transformers (GPTs) or other deep learning models, and may be capable of generating highly-realistic content similar to that which might be generated by a human content creator. For instance, the generative AI foundation model may be capable of generating content ranging from simple sentences to fully formed paragraphs, photorealistic images, audio tracks (e.g., music, speech, or the like), and even video content.

In optional step 406 (illustrated in phantom), the processing system may store the set of training data in a quantum temporal blockchain.

In one example, the quantum temporal blockchain provides a decentralized and secure environment for data storage and transaction recording. In one example, the quantum temporal blockchain stores the set of training data or metadata about the set of training data. Each block in the quantum temporal blockchain may contain a unique identifier, thereby ensuring that the data stored in the quantum temporal blockchain is tamper-proof and transparent.

In one example, steps 404-406 may be considered optional if the generative AI foundation model is pre-trained prior to execution of the subsequent steps of the method 400.

In step 408, the processing system may generate an item of new content based on an input, and using the generative artificial intelligence foundation model. In one example, the input may comprise a question or prompt provided by a user (e.g., a human user or an external system). The item of new content that is generated by the generative AI foundation model based on the input may have characteristics that mimic the characteristics of the set of training data, but may be tailored to satisfy any requirements of the input. For instance, if the set of training data included a plurality of contracts for the licensing of media, and the input comprised a prompt to generate a contract for the licensing of a specific item of media, then the item of new content may comprise a contract for the licensing of the specific item of media, where features of the contract (such as term of license, amounts of licensing fees and royalties, and the like) mimic features of the plurality of contracts contained in the training data. In another example, if the set of training data included records of transactions in which refunds were issued to travelers for cancelled flights, and the input comprised a prompt to issue a refund for a cancelled flight to an insured traveler who has a smart contract for travel insurance, then the item of new content may comprise an instruction to an airline system to process a refund for the insured traveler (where the instruction may include an amount of the refund, a form of the refund, and/or other information).

In step 410, the processing system may store the item of new content in the quantum temporal blockchain. In one example, the quantum temporal blockchain may include an entry for the item of new content that contains a plurality of fields for storing information related to the item of new content. In one example, the plurality of fields may include at least one of the following: a record identifier (e.g., a unique identifier that can be used to quickly locate and reference the entry for the item of new content in the quantum temporal blockchain), a quantum key distribution (QKD) session identifier (e.g., an identifier for a QKD session used to generate an encryption key for the item of new content), a QDS (e.g., a QDS that verifies the integrity of the entry for the item of new content in the quantum temporal blockchain), a timestamp (e.g., the time at which the generative AI foundation model generated the item of new content and added the item of new content to the quantum temporal blockchain), a model identifier (e.g., an identifier indicating which generative AI foundation model and/or which version of the generative AI foundation model was used to generate the item of new content), a content type of the item of new content (e.g., whether the item of new content comprises text, images, video, audio, or the like), or a content hash (e.g., a hashed representation of the item of new content, which may be generated by a QDS manager of a distributed resource controller). Depending upon the application for which the item of new content is generated (e.g., smart contracts, 5G/6G/Next Generation content, location information, etc.), additional fields may be included in the quantum temporal blockchain entry.

In step 412, the processing system may detect an action performed by the generative artificial intelligence foundation model against the item of new content. In one example, the action may comprise an action taken against a smart contract. For instance, in response to the detection of a predefined event or condition, the generative AI foundation model may take an action that the smart contract specified should be taken when the predefined event or condition occurs. As an example, a smart contract for travel insurance may specify that if an insured's flight is cancelled, a refund of the cost of the flight should be issued to the insured. Thus, if the generative AI foundation model detects that the insured's flight is cancelled, the generative AI foundation model may cause a refund to be issued to the insured, consistent with the terms of the smart contract.

In step 414, the processing system may log the action in the quantum temporal blockchain. For instance, as discussed above, in one example, the quantum temporal blockchain may store a smart contract. In this case, every transaction against the smart contract (e.g., a data access, an automated action such as the issuance of a refund for a cancelled flight, or the like), may be logged in the quantum temporal blockchain. In one example, once an action is logged in the quantum temporal blockchain (e.g., once a block recording the action is added to the quantum temporal blockchain), the logging cannot be undone or modified.

It should be noted that steps 412-414 may be repeated as additional actions taken by the generative AI foundation model against the item of new content are detected and logged. For instance, where the item of new content is a smart contract, the generative AI foundation model may generate automated actions to be taken in response to the occurrence of various events or conditions that are specified in the smart contract. The smart contract may specify a sequence of predefined events or conditions, and actions to be taken in response to the occurrence of each of these predefined events or conditions. The method 400 may end in step 416.

It should be noted that the method 400 may be expanded to include additional steps or may be modified to include additional operations with respect to the steps outlined above. In addition, although not specifically specified, one or more steps, functions, or operations of the method 400 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 4 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

Examples of the present disclosure therefore apply quantum temporal blockchain and QDS techniques to solve the inherent challenges related to the security, trust, and privacy in generative AI content. The immutable and decentralized nature of quantum temporal blockchains can be leveraged to ensure data privacy, prevent unauthorized use of data, and offer transparency and traceability of data in the generation of AI content. QDS can be used to enhance the security of quantum temporal blockchains by leveraging the principles of quantum mechanics to ensure the ingenuity and authenticity of transactions involving generative AI content. Thus, by integrating quantum temporal blockchains and QDS, examples of the present disclosure can provide a secure system that safeguards the security, authenticity, integrity, and non-repudiation of transactions involving generative AI content.

In one particular example, the systems and techniques disclosed herein can be applied to the field of smart contracts to provide innovative solutions, streamline processes, and enable new business models. The decentralized nature of the blockchain network in which the smart contracts would be deployed ensures that every participant in the blockchain network has access to a copy of the smart contract and can validate transactions independently. Thus, there is no single point of control to become a point of failure or manipulation. Moreover, smart contracts allow transactions to be carried out among disparate, anonymous parties, which allows the parties to work together without needing to expose their real-world identities.

The use of smart contracts renders transactions traceable and transparent. That is, each transaction executed by a generative AI foundation model against a smart contract would be recorded in a quantum temporal blockchain for the smart contract, creating an immutable and auditable trail of activity.

For instance, examples of the present disclosure may provide security, trust, and privacy for content generation and licensing, dynamic pricing and auctions, personalized recommendations, customized products and services, automated negotiations and agreements, data sharing and monetization, decentralized autonomous organizations (DAOs), smart contract code generation, smart contract code review and debugging, contract interpretation, and automated dispute resolution.

Within the context of content generation and licensing, a generative AI foundation model such as the model(s) described herein could be used to create unique content, including images, music, and/or written articles. Smart contracts could be used to manage the licensing and distribution of this unique content, thereby ensuring that creators are fairly compensated and that copyright in the unique content is respected.

Within the context of dynamic pricing and auctions, a generative AI foundation model such as the model(s) described herein could be used to analyze market data and to determine optimal pricing strategies for goods and services. Smart contracts could be used to automate the implementation of these pricing strategies by adjusting pricing for the goods and services in real time based on demand, inventory, and other factors. Additionally, smart contracts could be used to facilitate automated auctions, in which the generative AI foundation model could generate bids based on predefined criteria.

Within the context of personalized recommendations, a generative AI foundation model such as the model(s) described herein could be used to analyze a user's preferences and behaviors in order to create personalized recommendations for products, services, and/or content. Smart contracts could be used to automate the delivery of the personalized recommendations and to manage any transactions associated with the personalized recommendations (e.g., subscriptions to or purchases of recommended products, services, and/or content).

Within the context of customized products and services, a generative AI foundation model such as the model(s) described herein could be used to design customized products or services based on user inputs or preferences. Smart contracts could be used to manage the production, delivery, and payment processes for the customized products or services, thereby ensuring a seamless and efficient user experience.

Within the context of automated negotiation and agreements, a generative AI foundation model such as the model(s) described herein could be used to analyze contract terms and conditions in order to identify optimal negotiation strategies. Smart contracts could be used to execute these optimal negotiation strategies, thereby automating the negotiation process and creating legally binding agreements among parties.

Within the context of data sharing and monetization, a generative AI foundation model such as the model(s) described herein could be used to analyze and transform raw data into valuable insights. Smart contracts could be used to access these insights, thereby enabling secure and transparent data sharing among parties. Users could monetize their data by creating smart contracts that automatically compensate the users when the users' data is used by other parties.

Within the context of DAOs, a generative AI foundation model such as the model(s) described herein could be combined with smart contracts to create DAOs, which are self-governing entities that operate autonomously based on predefined rules. A generative AI foundation model such as the model(s) described herein could be used to make decisions or optimize processes within a DAO, while smart contracts could be used to enforce the predefined rules and manage transactions.

Within the context of smart contract code generation, a generative AI foundation model such as the model(s) described herein (e.g., a generative AI large language model) could be used to generate a quantum temporal blockchain smart computer code (e.g., a sequence of instructions that can be executed on a quantum computer) based on natural language processing requirements and a description of the purpose of the smart contract.

Within the context of smart contract code review and debugging, a generative AI foundation model such as the model(s) described herein (e.g., a generative AI large language model) could be trained to review smart contract code in order to detect bugs and vulnerabilities in the code.

Within the context of contract interpretation, a generative AI foundation model such as the model(s) described herein (e.g., a generative AI large language model) could be used to generate plain language descriptions of the purpose of a smart contract, based on the code of the smart contract.

Within the context of automated dispute resolution, a generative AI foundation model such as the model(s) described herein (e.g., a generative AI large language model) could be used to help interpret the terms of a quantum temporal blockchain smart contract in the event of a dispute over the contract. The generative AI foundation model could further interpret any relevant evidence presented by the contract parties in order to generate a proposed resolution.

In another example, the systems and techniques disclosed herein can be combined with location information, timestamp information, and geofencing in order to enhance the security and traceability of generative AI content. For instance, examples of the present disclosure may provide asset registration, access control, geofence enforcement, asset tracking and verification, and/or automated actions using smart contracts.

Within the context of asset registration, a smart contract can be used when an item of generative AI content is created or uploaded. The smart contract could be used to embed the timestamp of creation or upload and, if applicable, geofencing data, in the quantum temporal blockchain entry for the item of generative AI content, thereby ensuring the immutability and traceability of the item of generative AI content.

Within the context of access control, a smart contract could be designed to enforce access control policies based on location and geofencing data embedded in the quantum temporal blockchain entry for an item of generative AI content. For instance, a smart contract could grant access to the item of generative AI content only when the user requesting the access is physically located within a specified geographic area or if the access is requested during a specified time window.

Within the context of geofence enforcement, a smart contract could be used to monitor and enforce geofence rules for items of generative AI content. For instance, if a user attempts to access or share an item of generative AI content outside of a defined geofence associated with the item of generative AI content, the smart contract could automatically revoke the user's access to the item of generative AI content or trigger an alert, thereby ensuring compliance with locations-based restrictions on the access and sharing of the item of generative AI content.

Within the context of asset tracking and verification, smart contracts could be used to track and verify the location and timestamp information for an item of generative AI content throughout the lifecycle of the item of generative AI content, thereby helping to prevent unauthorized access, duplication, and distribution of the item of generative AI content as well as helping to ensure the accuracy and authenticity of the item of generative AI content.

Within the context of automated actions, smart contracts could be used to automate actions based on the digital location and/or geofencing data associated with an item of generative AI content. These automated actions could include releasing payments upon successful delivery of digital goods within a specified location and/or time frame, updating access permissions when an item of generative AI content enters or leaves a geofenced area, or the like.

FIG. 5 depicts a high-level block diagram of a computing device or processing system specifically programmed to perform the functions described herein. As depicted in FIG. 5, the processing system 500 comprises one or more hardware processor elements 502 (e.g., at least one central processing unit (CPU), a microprocessor, or a multi-core processor), a memory 504 (e.g., random access memory (RAM) and/or read only memory (ROM)), a module 505 for providing quantum computation-based security solutions for generative AI content, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 400 as discussed above is implemented in a distributed or parallel manner for a particular illustrative example, i.e., the steps of the above method 400 or the entire method 400 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 400. In one example, instructions and data for the present module or process 505 for providing quantum computation-based security solutions for generative AI content (e.g., a software program comprising computer-executable instructions) can be loaded into memory 504 and executed by hardware processor element 502 to implement the steps, functions, or operations as discussed above in connection with the illustrative method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for providing quantum computation-based security solutions for generative AI content (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

1. A method comprising:
generating, by a processing system including at least one processor, an item of new content by executing a generative artificial intelligence foundation model that has been trained to generate items of new content having characteristics that mimic characteristics of content included in a set of training data, wherein the item of new content is tailored by the generative artificial intelligence foundation model to satisfy a requirement of a prompt that the processing system provides as an input to the generative artificial intelligence foundation model;
storing, by the processing system, the item of new content in a quantum temporal blockchain;
detecting, by the processing system, an action performed by the generative artificial intelligence foundation model against the item of new content; and
logging, by the processing system, the action in the quantum temporal blockchain,
wherein the quantum temporal blockchain further stores at least one of: a record identifier of the item of new content, a quantum key distribution session identifier of the item of new content, a quantum digital signature of the item of new content, a model identifier of the generative artificial intelligence foundation model, a content type of the item of new content, or a hashed representation of the item of new content.

2. The method of claim 1, wherein the generative artificial intelligence foundation model is based in a deep learning technique.

3. The method of claim 1, wherein the item of new content comprises at least one of: a text content, an image content, an audio content, or a video content.

4. The method of claim 1, wherein the item of new content comprises a smart contract.

5. The method of claim 1, wherein the quantum temporal blockchain further stores a smart contract that governs a manner in which the item of new content is distributed.

6. The method of claim 5, wherein the action comprises an action that the smart contract specifies is to be taken in response to an occurrence of a predefined condition.

7. The method of claim 1, wherein the quantum temporal blockchain further stores the set of training data used to train the generative artificial intelligence foundation model.

8. The method of claim 1, wherein the item of new content and the action are stored in the quantum temporal blockchain as at least one Greenberger-Horne-Zeilinger qubit.

9. The method of claim 1, wherein the quantum temporal blockchain further stores at least one of: a location of the item of new content or geofence data associated with the item of new content.

10. The method of claim 1, wherein the action comprises an access of the item of new content by a user.

11. The method of claim 1, wherein the action comprises a modification of the item of new content by a user.

12. The method of claim 1, wherein the action comprises a portion of a negotiation process for creating an agreement among a plurality of parties.

13. The method of claim 1, wherein the item of new content comprises a sequence of instructions for execution on a quantum computer.

14. The method of claim 1, wherein the item of new content is hashed using a cryptographic hash function and digitally signed using a quantum entanglement-based algorithm prior to the storing.

15. The method of claim 1, wherein the item of new content comprises a key performance indicator for a slice of a radio access network.

16. The method of claim 1, wherein the item of new content comprises an anomaly in a network traffic pattern for a slice of a radio access network.

17. The method of claim 1, wherein the generating, the storing, the detecting, and the logging are performed by a distributed resource controller that is in communication with the generative artificial intelligence foundation model and the quantum temporal blockchain.

18. The method of claim 1, wherein the quantum temporal blockchain further stores at least one of: a timestamp indicating when the item of new content was generated or a timestamp indicating when the item of new content was stored in the quantum temporal blockchain.

19. A non-transitory computer-readable medium storing instructions which, when executed by a processing system including at least one processor, cause the processing system to perform operations, the operations comprising:
generating an item of new content by executing a generative artificial intelligence foundation model that has been trained to generate items of new content having characteristics that mimic characteristics of content included in a set of training data, wherein the item of new content is tailored by the generative artificial intelligence foundation model to satisfy a requirement of a prompt that the processing system provides as an input to the generative artificial intelligence foundation model;
storing the item of new content in a quantum temporal blockchain;
detecting an action performed by the generative artificial intelligence foundation model against the item of new content; and
logging the action in the quantum temporal blockchain,
wherein the quantum temporal blockchain further stores at least one of: a record identifier of the item of new content, a quantum key distribution session identifier of the item of new content, a quantum digital signature of the item of new content, a model identifier of the generative artificial intelligence foundation model, a content type of the item of new content, or a hashed representation of the item of new content.

20. A device comprising:
a processing system including at least one processor; and
a non-transitory computer-readable medium storing instructions which, when executed by the processing system, cause the processing system to perform operations, the operations comprising:
generating an item of new content by executing a generative artificial intelligence foundation model that has been trained to generate items of new content having characteristics that mimic characteristics of content included in a set of training data, wherein the item of new content is tailored by the generative artificial intelligence foundation model to satisfy a requirement of a prompt that the processing system provides as an input to the generative artificial intelligence foundation model;
storing the item of new content in a quantum temporal blockchain;
detecting an action performed by the generative artificial intelligence foundation model against the item of new content; and
logging the action in the quantum temporal blockchain,
wherein the quantum temporal blockchain further stores at least one of: a record identifier of the item of new content, a quantum key distribution session identifier of the item of new content, a quantum digital signature of the item of new content, a model identifier of the generative artificial intelligence foundation model, a content type of the item of new content, or a hashed representation of the item of new content.
